(19) United States
(12) Patent Application Publication
(10) Pub. No.: US 2020/0310544 A1
(43) Pub. Date: Oct. 1, 2020

(54) STANDING WAVE PATTERN FOR AREA OF INTEREST

(71) Applicant: Lenovo (Singapore) Pte. Ltd., Singapore (SG)

(72) Inventors: Justin Michael Ringuette, Morrisville, NC (US); Robert James Norton, JR., Raleigh, NC (US)

(21) Appl. No.: 16/369,010

(22) Filed: Mar. 29, 2019

(51) Int. Cl. G06F 3/01; G06F 3/0488

(52) U.S. Cl. CPC G06F 3/016; G06F 3/0488

(57) ABSTRACT

One embodiment provides a method, including: determining, using a processor, at least one area of interest on a display screen of an information handling device; identifying at least one haptic source corresponding to the at least one area of interest; and directing, based on the identifying, the at least one haptic source to produce a standing wave pattern. Other aspects are described and claimed.

### BACKGROUND

Touchscreens on information handling devices (“devices”), for example, smartphones, tablets, laptops, hybrid devices, and the like, allow users to interact with a device in easy and intuitive ways. For example, a user may navigate through menus displayed on the device and perform various selection and input operations by simply using their finger or stylus. Most modern devices are capable of producing a haptic effect at a location where touch input is received.

### BRIEF SUMMARY

In summary, one aspect provides a method, comprising: determining, using a processor, at least one area of interest on a display screen of an information handling device; identifying at least one haptic source corresponding to the at least one area of interest; and directing, based on the identifying, the at least one haptic source to produce a standing wave pattern.

Another aspect provides an information handling device, comprising: a display screen; a processor; a memory device that stores instructions executable by the processor to: determine at least one area of interest on the display screen; identify at least one haptic source corresponding to the at least one area of interest; and direct, based on the identifying, the at least one haptic source to produce a standing wave pattern.

A further aspect provides a product, comprising: a storage device that stores code, the code being executable by a processor and comprising: code that determines at least one area of interest on a display screen of an information handling device; code that identifies at least one haptic source corresponding to the at least one area of interest; and code that directs, based on the identifying, the at least one haptic source to produce a standing wave pattern.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of directing one or more haptic sources to produce a standing wave pattern.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The advent of touch-based displays (“touchscreens”) has expanded the functionality of many devices and has also made interaction with these devices more intuitive and enjoyable. However, unlike predecessor devices that comprise a plurality of analog buttons, touchscreens are flat, featureless surfaces that lack tactile references and require visual attention to identify virtual buttons (e.g., numbers on a keypad, letters on a keyboard, other touchable objects, etc.). This requirement creates issues for users who have visual impairments or that are unable to devote their immediate visual attention to the touchscreen (e.g., users that are driving or otherwise preoccupied with another task, etc.).

Conventional solutions exist for mimicking the tactile sensation of a physical button. For example, users may receive some sort of haptic feedback when they interact with their device (e.g., when a user unlocks their device, while a user crafts a text message, etc.). However, this haptic effect is temporary and goes away after the initial contact with a touch location. As another example, a microfluid layer between the touchscreen and liquid crystal display (“LCD”) layers may raise and lower segments of a touchscreen to create a feeling of stiffness. However, such a solution is expensive and significantly increases the complexity of the touchscreen and/or the device comprising the touchscreen. Furthermore, the foregoing solution may introduce issues with image clarity (e.g., because the touchscreen is no longer substantially level, etc.) and is limited to raising and lowering shapes that are pre-defined by the physical design of the device.

Accordingly, an embodiment may utilize one or more haptic sources to produce a standing wave across the touchscreen that may be directed to one or more areas of interest on the touchscreen. In an embodiment, a location of at least one area of interest (e.g., a button, a keypad, another object, etc.) on a touchscreen of a device may be determined. An embodiment may then identify at least one haptic source (e.g., a vibrator, a dampener, another type of actuator, etc.) that corresponds to the area of interest(s) and thereafter direct the haptic source to produce a standing wave pattern at the location corresponding to the area of interest. Such a method may leverage one or more haptic sources to change a standing wave pattern dynamically (e.g., as new areas of interest are encountered, etc.) and/or may highlight multiple areas of interest simultaneously. Additionally, such a method may preserve the display integrity as a system of the foregoing does not need to be integrated within the display itself, but rather, may be at its edges or elsewhere within the device.

The illustrated example embodiments will be best understood by reference to the figures. The following description is intended only by way of example, and simply illustrates certain example embodiments.

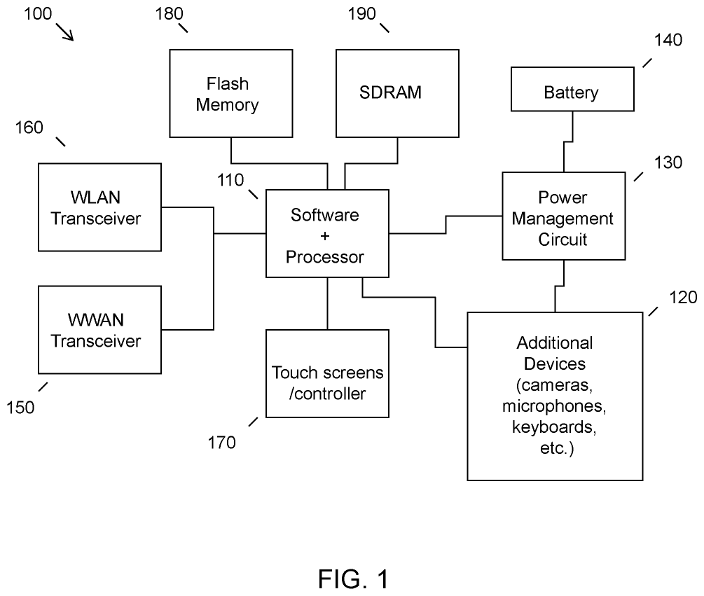

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, external keyboard, other input devices, etc. System 100 often includes one or more touch screens 170 for data input and display/rendering. System 100 also typically includes various memory devices, for example flash memory 180 and SDRAM 190.

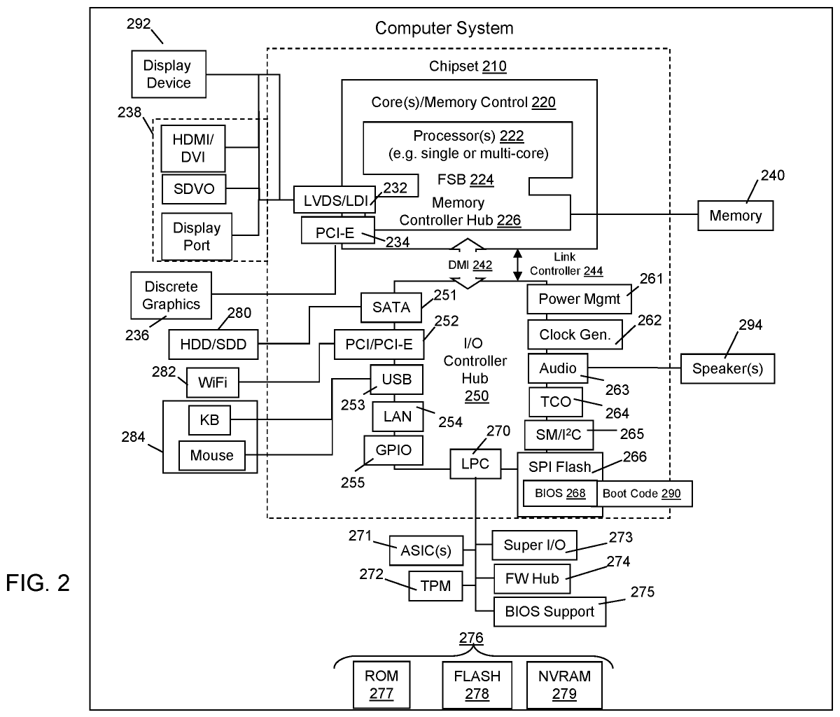

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops, personal computer devices generally, and/or other electronic devices that may be capable of producing a standing wave pattern by utilizing one or more haptic sources. For example, the circuitry outlined in FIG. 1 may be implemented in a tablet or smart phone embodiment, whereas the circuitry outlined in FIG. 2 may be implemented in a laptop.

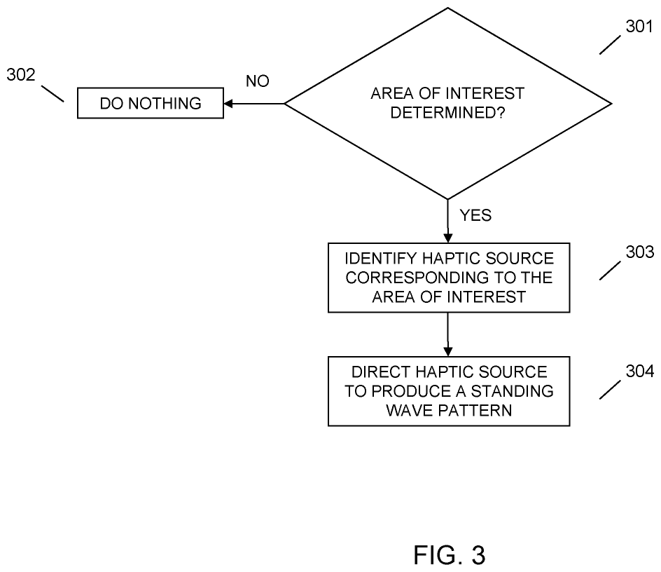

Referring now to FIG. 3, an embodiment may dynamically create a standing wave pattern for one or more areas of interest of a touchscreen. At 301, an embodiment may determine a location of at least one area of interest on a touchscreen of a device. In the context of this application, an area of interest is a broad term that may correspond to virtually any portion of the touchscreen that may be of some interest to the user. For example, an area of interest may correspond to a displayed object a user may interact with (e.g., a keypad, one or more alphanumerical buttons, an icon, an input field, another object, etc.). Conversely, the area of interest may correspond to one or more objects that may not be explicitly visible to the user. For example, an area of interest may correspond to a border portion of an application window or an edge of some other object.

In an embodiment, the areas of interest may be dependent upon an active application. For example, for a text messaging application, the areas of interest may correspond to an input field or the alphanumerical keypad generally positioned near the bottom of the application window. As another example, in a gaming application, the areas of interest may correspond to one or more buttons that may control the actions of a digital character in a game. In yet another example, the areas of interest may correspond to application borders that may help identify the boundaries of one or more concurrently displayed applications on a touchscreen.

In addition to the foregoing, the areas of interest may also be dependent upon a size and/or position of the application window and the contents thereof. Stated differently, the areas of interest may dynamically change as application windows are opened and closed, resized, and/or repositioned to another portion of the touchscreen. As an example, if an area of interest corresponded to a button in an application window originally positioned at the bottom of the touchscreen, but later moved to the top of the touchscreen, an embodiment may identify that the area of interest has changed to a new location. In another example, if the aforementioned button was originally comprised of size A, but later expanded to size B, then an embodiment may identify that the area of interest has expanded. In yet a further example, if the application window comprising the aforementioned button was closed or minimized, the portion of the touchscreen previously corresponding to the button may no longer be identified as an area of interest.

In an embodiment, the areas of interest may be dynamically identified based upon one or more predetermined settings. For example, a user may wish to designate each selectable button and keypad in an application window or icon displayed on the home screen as an area of interest. Additionally or alternatively, a user may wish to designate each application border as an area of interest. In an embodiment, the predetermined settings may be stored at an accessible data store (e.g., stored locally on the device or remotely on another device or server, etc.). In an embodiment, the predetermined settings may be originally set by a manufacturer and/or may later be adjusted by a user.

Responsive to not determining, at 301, any areas of interest, an embodiment may, at 302, take no additional action. Conversely, responsive to determining, at 301, at least one area of interest, an embodiment may, at 303, identify a haptic source that corresponds to the location of the touchscreen associated with the area of interest.

In an embodiment, a haptic source may correspond to one or more devices capable of providing a haptic effect. For example, a haptic source may be a vibrator, a dampener, another type of actuator, etc. In the context of this application, a haptic source corresponding to a location of an area of interest may be associated with a haptic source that may be able to produce a haptic effect at the location of the area of interest. In an embodiment, the haptic source(s) may be positioned underneath the touchscreen, at the edges of the touchscreen, elsewhere within the device, etc. In this way, the integrity of the touchscreen of the underlying embodiments is preserved as such systems do not need to be integrated within the touchscreen itself.

In an embodiment, the identification of the haptic sources may be facilitated by accessing a data store comprising location information for each haptic source. More particularly, knowledge identifying the locations for each haptic source may be hardwired into the data store at the time of manufacture and may be retrieved when needed. Accordingly, responsive to an embodiment identifying an area of interest, an embodiment may substantially simultaneously identify one or more haptic sources that correspond to that area.

At 304, an embodiment may direct the haptic source(s) to produce a standing wave pattern at the location corresponding to the area of interest. In the context of this application, the standing wave pattern may correspond to a standing haptic effect produced at a predetermined frequency. More particularly, the standing nature of the haptic effect may feel, to a user, as a solid object when touched. In this regard, the standing wave may therefore mimic the tactile sensations a user may have when interacting with virtual buttons.

In an embodiment, the predetermined frequency may be originally set by a manufacturer and then later adjusted by a user. Additionally or alternatively, the predetermined frequency may vary for different areas of interest. More particularly, as an example, the standing wave pattern for a button in an application may be produced at frequency A whereas the standing wave pattern for an application edge or border may be produced at frequency B. In this way, different areas of interest may feel different to a user.

In an embodiment, as an area of interest is repositioned, resized, or removed, the standing wave pattern may correspondingly automatically adjust. For example, if an area of interest is repositioned from a bottom of the touchscreen to the top of the touchscreen, the original haptic sources may cease producing a standing wave and the new haptic sources (i.e., those haptic sources identified as corresponding to the new location of the area of interest) may thereafter automatically activate and being producing the standing wave at the same frequency as the original haptic sources. As another example, if an area of interest is expanded, then an embodiment may dynamically activate more haptic devices that correspond to the expanded portions of the area of interest. Conversely, if an area of interest is decreased, then an embodiment may automatically deactivate those haptic sources that no longer correspond to the area of interest.

In an embodiment, the haptic sources may only activate when it is detected that an input source is within a predetermined distance from the touchscreen. More particularly, as an example, an embodiment may use one or more sensors (e.g., proximity sensors, camera sensors, etc.) to identify when a user's finger, or stylus, has come within a predetermined distance from the touchscreen. At this point, an embodiment may direct the haptic sources corresponding to the areas of interest to automatically activate to produce the standing wave. Additionally, when the input source has moved outside of the predetermined distance, an embodiment may automatically direct the haptic sources to stop producing the standing wave. In this way, an embodiment may conserve power by not maintaining haptic devices in an on-state when a user has no use for them.

The various embodiments described herein thus represent a technical improvement to conventional location/object identification techniques on a touchscreen. Using the techniques described herein, an embodiment may first determine at least one area of interest on a touchscreen of a device. The area of interest may correspond to any of a user-selectable object (e.g., button, icon, keypad, etc.) or a non-visible and/or non-selectable object (e.g., edges of an application window, edges of an input field, etc.). An embodiment may then identify a haptic source corresponding to the area of interest and thereafter direct the haptic source to produce a standing wave pattern (e.g., emitted at a predetermined frequency, etc.) for the area. Such a method may allow users to locate certain objects displayed on the screen without requiring the user to direct their visual focus to the touchscreen.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
determining, using a processor, at least one area of interest on a display screen of an information handling device;
identifying at least one haptic source corresponding to the at least one area of interest;
directing, based on the identifying, the at least one haptic source to produce a standing wave pattern at a position associated with the at least one area of interest;
receiving an indication to relocate the at least one area of interest to another position on the display screen;
identifying at least one other haptic source that corresponds to the another position; and
directing the at least one other haptic source to produce another standing wave pattern at the another position associated with the relocated at least one area of interest.

2. The method of claim 1, wherein the at least one area of interest corresponds to a predetermined portion of the display screen.

3. The method of claim 1, wherein the at least one area of interest corresponds to at least one characteristic of an application.

4. The method of claim 3, wherein the at least one characteristic comprises at least one input object selected from the group consisting of a button, a keypad, an input field, an icon, and an application border.

5. The method of claim 1, wherein the determining the at least one area of interest comprises identifying an input location of an input object.

6. The method of claim 1, wherein the at least one haptic source comprises at least one of a vibrator and a dampener.

7. The method of claim 1, wherein the at least one haptic source is dynamically identified based upon the at least one area of interest.

8. The method of claim 1, wherein the standing wave pattern is produced at a predetermined frequency.

9. The method of claim 1, wherein the at least one area of interest comprises a plurality of areas of interest and wherein the standing wave pattern comprises a multitude of standing wave patterns, wherein each of the multitude of standing wave patterns exist simultaneously and correspond to one of the plurality of areas of interest.

10. The method of claim 1, wherein the directing comprises directing the at least one haptic source to produce the standing wave pattern when an input object is detected within a predetermined proximity of the display screen.

11. An information handling device, comprising:
a display screen;
a processor;
a memory device that stores instructions executable by the processor to:
determine at least one area of interest on the display screen;
identify at least one haptic source corresponding to the at least one area of interest;
direct, based on the identifying, the at least one haptic source to produce a standing wave pattern at a position associated with the at least one area of interest;
receive an indication to relocate the at least one area of interest to another position on the display screen;
identify at least one other haptic source that corresponds to the another position; and
direct the at least one other haptic source to produce another standing wave pattern at the another position associated with the relocated at least one area of interest.

12. The information handling device of claim 11, wherein the at least one area of interest corresponds to a predetermined portion of the display screen.

13. The information handling device of claim 11, wherein the at least one area of interest corresponds to at least one characteristic of an application.

14. The information handling device of claim 13, wherein the at least one characteristic comprises at least one input object selected from the group consisting of a button, a keypad, an input field, an icon, and an application border.

15. The information handling device of claim 11, wherein the instructions executable by the processor to determine the at least one area of interest comprise instructions executable by the processor to identify an input location of an input object.

16. The information handling device of claim 11, wherein the at least one haptic source comprises at least one of a vibrator and a dampener.

17. The information handling device of claim 11, wherein the standing wave pattern is produced at a predetermined frequency.

18. The information handling device of claim 11, wherein the at least one area of interest comprises a plurality of areas of interest and wherein the standing wave pattern comprises a multitude of standing wave patterns, wherein each of the multitude of standing wave patterns exist simultaneously and correspond to one of the plurality of areas of interest.

19. The information handling device of claim 11, wherein the instructions executable by the processor to direct comprise instructions executable by the processor to direct the at least one haptic source to produce the standing wave pattern when an input object is detected within a predetermined proximity of the display screen.

20. A product, comprising:
a storage device that stores code, the code being executable by a processor and comprising:
code that determines at least one area of interest on a display screen of an information handling device;
code that identifies at least one haptic source corresponding to the at least one area of interest;
code that directs, based on the identifying, the at least one haptic source to produce a standing wave pattern at a position associated with the at least one area of interest;
code that receives an indication to relocate the at least one area of interest to another position on the display screen;
code that identifies at least one other haptic source that corresponds to the another position; and
code that directs the at least one other haptic source to produce another standing wave pattern at the another position associated with the relocated at least one area of interest.
